(19) United States
(12) Patent Application Publication
(10) Pub. No.: US 2006/0215051 A1
(43) Pub. Date: Sep. 28, 2006

(54) Display device

(75) Inventor: Atsushi Misawa, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/387,721

(22) Filed: Mar. 24, 2006

(30) Foreign Application Priority Data
Mar. 24, 2005 (JP) 2005-086955
Mar. 24, 2005 (JP) 2005-086956

(51) Int. Cl. H04N 5/222

(52) U.S. Cl. 348/333.01

(57) ABSTRACT

According to the display device of the present invention, when an image is displayed on the entire display screen, the plate-like member with the switch member is placed in the position saved from the display screen. Therefore, a large screen can be realized during display. When a device body is gripped and operated, the plate-like member is placed in a position covering part of the display screen, and the plate-like member is used also as a grip portion. Therefore, the gripping capability during operation can be improved. Additionally, since a user only had to touch the plate-like member covering part of the display screen during operation, the dirt of the display screen caused by the touch of a finger can be prevented because a user only touches the plate-like member obtained by covering part of the display screen during operation.

### BACKGROUND OF THE INVENTION

1. Field of the Invention

The present invention relates to a display device, and more specifically to a display device capable of performing various operations by operating a plate-like member with a switch member positioned on the display screen.

2. Description of the Related Art

A device such as a video player, an electronic camera such as a digital camera, etc. a mobile telephone with a camera, a personal digital assistant (PDA), a portable game player, etc., is provided with a display device including a liquid crystal monitor, etc. On the display screen of the display device, for example, a camera displays a through image before shooting or a shot image.

Recently, with an increasing number of downsized equipment, a larger screen size is requested to display a dynamic and visible image on the display device. At the request, the above listed devices are provided with a display device having a large screen. However, the larger the area of the display screen relative to the size of the grip of the device held in an operation, the smaller the grip portion in holding the device during the operation. Therefore, it is hard for a user to hold the device, and the operability of the device is reduced. There is another problem that a user easily touches the display screen and a part of an image becomes invisible.

Thus, to solve the above-mentioned problems, the inventor of the present invention proposes in Japanese Patent Application Laid-open No. 11-289484 a camera with a monitor capable of replaying a dynamic image on a large screen monitor in a replaying process, using a part of a display screen hidden by the hand holding a camera during shooting as a touch panel whose screen is not displayed, and holding the portion of the touch panel, thereby improving the grip capability.

With the camera with the monitor according to Japanese Patent Application Laid-open No. 11-289484, only the composition is to be confirmed on the display screen during shooting, and no image is appreciated. Therefore, a large screen is not required, but a grip capability is to be enhanced to improve the operability during shooting. As a result, a touch panel is used also as a grip portion. An image is reduced to a size for other uses than a touch panel, and displayed on the screen.

### SUMMARY OF THE INVENTION

Although the camera with the monitor according to Japanese Patent Application Laid-open No. 11-289484 uses part of the display screen on which no image is displayed during shooting as a touch panel, a user directly touches the display screen when operating the touch panel. Therefore, when an image is displayed on the entire screen during replay, a part of the display screen used as a touch panel become dirty by the touch of a finger. Accordingly, the image displayed on the part cannot be clearly recognized. Since the dirt can cause external light reflection, it is hard to recognize an image by reflection in the bright outdoor.

The present invention has been developed to solve the above-mentioned problems, and aims at providing a display device capable of obtaining a large screen which appreciates displayed data during replay, etc. and improving the gripping capability during operation, and preventing the dirt of the screen caused by the touch of a finger.

To attain the above-mentioned objective, a first aspect of the present invention comprises: a device body having a display screen; and a plate-like member with a switch member, the plate-like member movable to a position covering part of the display screen and a position saved from the display screen.

According to the first aspect of the invention, when an image is displayed on the entire display screen, a plate-like member with a switch member is placed in the position saved from the display screen. Thus, a large screen can be realized during display. When a device body is gripped and operated, the plate-like member is moved to a position covering part of the display screen, and the plate-like member is used also as a grip portion. Thus, the gripping capability is improved during operation, and the dirt of the display screen caused by the touch of a finger can be prevented because a user only touches the plate-like member obtained by covering part of the display screen during operation.

In the present invention, the plate-like member may be a so-called “touch panel”.

In the present invention, the switch member in the plate-like member may be capacitance-detection type, pressure-sensitive type, or a non-contact type censor (a light sensor, etc.).

A second aspect of the present invention is based on the first aspect, and the device body has a landscape format, the display screen has a landscape format, and the plate-like member is stored in the device body and moved between a storage position and the position covering part of the display screen.

The second aspect of the present invention designates the shapes of the device body and the display screen. That is, the device body has a landscape format, and the display screen has a landscape format. The plate-like member is stored and is moved between the storage position and the position covering part of the display screen. By placing and removing the plate-like member at the right side on the display screen, the plate-like member can be preferably used as a grip.

A third aspect of the present invention is based on the first or second aspect, and further comprises a record-replay switch device. The plate-like member is moved between the position covering part of the display screen and the position saved from the display screen in synchronization with a switching operation of the record-replay switch device. The plate-like member can be used in an operation relating to recording in the position covering part of the display screen.

According to the third aspect of the present invention, when the record-replay switch device is switched to the recording position, the plate-like member is placed in the position covering part of the display screen in synchronization with the switching operation, and the operation relating to recording in the position can be performed. When the record-replay switch device is switched to the replaying position, the plate-like member is placed in the position saved from the display screen in synchronization with the switching operation, thereby improving the operability.

A fourth aspect of the present invention is based on the first, second, or third aspect, and the plate-like member is configured by a flexible material, and is flexed and moved from the position covering part of the display screen on a front surface of the display screen to the position on a back of the display screen and saved from the front surface of the display screen.

According to the fourth aspect of the present invention, the plate-like member is configured by a flexible material, for example, a plastic sheet, and it is flexed and moved from the position obtain by covering part of the display screen on the front surface of the display screen to the position on the back of the display screen saved from the front surface of the display screen, thereby saving a storage space of the touch panel and realizing a compact device body.

A fifth aspect of the present invention is based on the third or fourth aspect, and further comprises a capture unit and a barrier member which opens and closes a front surface of the capture unit. The barrier member is moved to a position in which the front surface of the capture unit is opened and a position in which the front surface of the capture unit is closed in synchronization with an operation of the record-replay switch device.

According to the fifth aspect of the present invention, when the record-replay switch device is switched to the recording position, a barrier member is moved to the position of releasing the front surface of the capture unit in synchronization with the switching operation. Therefore, the capture unit can record an image. When the record-replay switch device is switched to the replaying position, the barrier member is moved to the position in which the front surface of the capture unit is blocked in synchronization with the switching operation. Since the capture unit is not operated during replay, the front surface of the capture unit is blocked by the barrier member, thereby protecting the capture unit. Thus, the operability can be improved by operating the barrier member in synchronization with the record-replay switch device.

A sixth aspect of the present invention is based on the first, second, third, fourth, or fifth aspect, and the plate-like member is a photo transmissive touch panel.

According to the sixth aspect of the present invention, the screen covered by the plate-like member can be seen through the plate-like member by preparing a photo transmissive touch panel, and a highly operable display device can be provided by displaying an image corresponding to the operation on the screen covered by the plate-like member.

To attain the above-mentioned objective, a seventh aspect of the present invention comprises: a device body having a display screen; a plate-like member with a switch member, the plate-like member movable to a first position covering part of the display screen and a second position covering an area smaller than the part of the display screen; and a display control device which changes a display style of the display screen depending on a movement of the plate-like member from the second position to the first position.

According to the seventh aspect of the present invention, the plate-like member is configured to be movable between the position covering part of the display screen of the display device and the position covering an area smaller than the part, and the display style on the display screen is switched by the display switch device in synchronization with the movement of the plate-like member. According to the seventh aspect of the present invention, for example, in a camera, since a large area for use as a grip portion can be reserved by placing the plate-like member in the position covering part of the display screen during shooting when a large screen is not required, the gripping capability during operation can be improved. Additionally, since a user only has to touch the plate-like member covering part of the display screen during operation, the dirt on the display screen possibly caused by the touch of a finger can be prevented. At this time, a through image is displayed on the screen except the part. For example, if the plate-like member is placed in the position covering part of the display screen of the display device, the display switch device switches the display style such that an image can be displayed on the screen except the part. On the other hand, since the minimal number of operation buttons are provided during replay, and the plate-like member is placed in the position in which the operation buttons are exposed, that is, in the position covering an area smaller than the part, a large screen can be realized during replay with the minimal number of operation buttons for replay successfully reserved. For example, when the plate-like member is moved from the first position to the second position, the display switch device switches the display style such that an image can be displayed on the entire display screen.

An eighth aspect of the present invention comprises a device body having a display screen, and a plate-like member with a switch member, the plate-like member movable a position covering the display screen and a position saved from the display screen. The plate-like member is configured by a flexible material, and is flexed and moved from a position covering all or part of the display screen on a front surface of the display screen to a position on a back of the display screen saved from the front surface of the display screen.

According to the eighth aspect of the present invention, the plate-like member is configured by a flexible material, for example, a plastic sheet, and is flexed and moved from the position covering all or part of the display screen on the front surface of the display screen to the position on the back of the display screen saved from the front surface of the display screen. Thus, since the storage space of the plate-like member can be saved, the entire device can be compact. By the plate-like member covering the entire display screen, the plate-like member can protect the display screen.

To attain the above-mentioned objective, a ninth aspect of the present invention comprises a device body having a display screen, a plate-like member with a switch member, the plate-like member movable to a position covering all or part of the display screen, and a position saved from the display screen.

According to the ninth aspect of the present invention, when an image is displayed on the entire display screen, the plate-like member is placed in the position saved from the display screen. Thus, a large screen can be realized during display. When the device body is gripped and operated, the plate-like member is placed in the position covering all or part of the display screen, and is used also as a grip portion. Thus, the gripping capability during operation can be improved, and a user only has to touch the plate-like member obtained by covering all or part of the display screen during operation. Therefore, the dirt on the display screen caused by the touch of a finger can be prevented.

A tenth aspect of the present invention is based on the ninth aspect. The device body has a portrait format, the display screen has a landscape format, and the plate-like member is stored in the device body and moved between a storage position and the position covering all or part of the display screen.

The tenth aspect of the present invention designates the shapes of the device body and the display screen. That is, the device body has a portrait format, and the display screen has a landscape format. The plate-like member is stored in the device body, and is moved between the storage position and the position covering all or part of the display screen. By moving upwards from the lower portion of the display screen, the touch panel can be preferably used as a grip.

An eleventh aspect of the present invention is based on the ninth or tenth aspect. The plate-like member is configured by a photo transmissive member, and when the plate-like member is moved to a position covering all or part of the display screen, the display screen displays an image related to an operation of the touch panel.

According to the eleventh aspect of the present invention, by using a photo transmissive touch panel, the screen covered by the plate-like member can be seen through the plate-like member, and by displaying an image related to the operation of the plate-like member on the screen covered by the plate-like member, a highly operable display device can be provided.

A twelfth aspect of the present invention is based on the tenth aspect. The plate-like member is configured to be movable to a first position covering part of the display screen and a second position covering an area smaller than the part of the display screen, and a display control device is provided to change a display style of the display screen depending on a movement of the touch panel from the second position to the first position.

According to the twelfth aspect of the present invention, the plate-like member is configured to be movable between the position covering part of the display screen of the display device and the position covering an area smaller than the part, and a display switch device switches the display style on the display screen in synchronization with the movement of the plate-like member. During operation where no large screen is required, a larger area for use as a grip portion can be reserved by placing the plate-like member in the position covering part of the display screen. Therefore, the gripping capability during operation can be improved. Additionally, since a user only has to touch the plate-like member covering part of the display screen during operation, the dirt of the display screen caused by the touch of a finger can be prevented. At this time, the operation image is displayed on the screen except the part. On the other hand, the minimal operation buttons are provided on the plate-like member, and the touch panel is placed in the position covering an area smaller than the part. Therefore, a large screen can be realized with the minimal number of operation buttons during replay successfully reserved.

A thirteenth aspect of the present invention is based on the ninth, tenth, or twelfth aspect, and further comprises a display control device which changes an aspect ratio of an image displayed on the display screen depending on a movement position of the plate-like member.

According to the thirteenth aspect of the present invention, the aspect ratio of an image is changed such that an image can be fully displayed on the display screen except the overlapping portion of the plate-like member. Therefore, the image can be easily seen. For example, by setting the aspect ratio (length-to-width ratio) to 3:4 on the display screen on which the plate-like member does not overlap, a screen of a standard size can be appreciated. By setting the aspect ratio (length-to-width ratio) to 9:16 on the display screen on which the plate-like member does not overlap, the screen can be switched to a wide screen.

To attain the above-mentioned objective, a fourteenth aspect of the present invention comprises: a device body having a display screen; a plate-like member with a switch member, the plate-like member movable to a position covering all or part of the display screen and a position saved from the display screen; and a mode switch device which switches replay modes between an image replay mode and a music replay mode depending on a movement position of the plate-like member.

According to the fourteenth aspect of the present invention, when the plate-like member is placed in the position saved from the display screen, the mode switch device switches replay mode to an image replay mode. When the plate-like member is placed in the position covering the entire display screen, the mode switch device switches replay mode to a music replay mode. In this case, the plate-like member has an operation button used during music replay in addition to the operation button used during image replay on the display screen. Furthermore, when the plate-like member is placed in a position covering part of the display screen, one of the image replay mode and the music replay mode is selected.

A fifteenth aspect of the present invention is based on the fourteenth aspect. The plate-like member is configured by a photo transmissive member, and when the plate-like member is moved to a position covering entire display screen, the mode switch device switches replay mode to the music replay mode and the display screen displays an image related to an operation of the plate-like member in the music replay mode.

According to the fifteenth aspect of the present invention, when a photo transmissive touch panel is placed in a position covering the part of the display screen, the mode switch device switches replay mode to the music replay mode, and the display screen displays an image related to the operation of the plate-like member in the music replay mode. For example, when a music selection button formed on the plate-like member is operated, characters showing plural titles of music are displayed, and a title of music can be selected by operating a determination button formed on the plate-like member. According to the display device of the present invention, when an image is displayed on the entire display screen, the plate-like member is placed in the position saved from the display screen. Therefore, a large screen can be realized during display. When a device body is gripped and operated, the plate-like member is placed in a position covering part of the display screen, and the plate-like member is used also as a grip portion. Therefore, the gripping capability during operation can be improved. Additionally, since a user only has to touch the plate-like member covering part of the display screen during operation, the dirt of the display screen caused by the touch of a finger can be prevented.

According to the display device of the present invention, when a device body is gripped and operated, the plate-like member is placed in the position covering all or part of the display screen, and can be also used as a grip portion. Therefore, the gripping capability during operation can be improved, and a user only has to touch the plate-like member covering all or part of the display screen. As a result, the dirt of the display screen caused by the touch of a finger can also be prevented.

### BRIEF DESCRIPTION OF THE DRAWINGS

FIG. 1 is a front view of the electronic camera according to an embodiment of the present invention;

FIG. 2 is a rear elevation of the electronic camera shown in FIG. 1, and an explanatory view in a replay mode;

FIG. 3 is a perspective view partly including the sectional view of the electronic camera shown in FIG. 2;

FIG. 4 is a rear elevation of the electronic camera shown in FIG. 1, and an explanatory view in a shooting mode;

FIG. 5 is a perspective view partly including the sectional view of the electronic camera shown in FIG. 4;

FIG. 6 is an explanatory view of a block diagram of the entire configuration of the electronic camera shown in FIG. 1;

FIGS. 7A, 7B, and 7C are explanatory views partly including the sectional view of the electronic camera according to another embodiment of the present invention;

FIG. 8 is a front view of the status shown in FIG. 7A;

FIGS. 9A, 9B, 9C, and 9D are explanatory views showing the relationship between a touch panel and a shutter button;

FIG. 10 is a front view of the video player according to an embodiment of the present invention;

FIG. 11 is a longitudinal sectional view of the video player shown in FIG. 10;

FIG. 12 is an explanatory view of an image of a standard size displayed on the monitor of the video player shown in FIG. 10;

FIG. 13 is an explanatory view of an image of a wide size displayed on the monitor of the video player shown in FIG. 10;

FIG. 14 is an explanatory view of the structure of the potentiometer which detects the position of a touch panel;

FIG. 15 is a block diagram showing the entire configuration of the video player shown in FIG. 10;

FIG. 16 is a front view showing an embodiment of a video-audio player;

FIG. 17 is a front view of the status in which the video-audio player shown in FIG. 16 is switched to the music replay mode;

FIG. 18 is a block diagram showing the entire configuration of the video-audio player shown in FIG. 16;

FIG. 19 is a front view showing another embodiment of a video player; and

FIG. 20 is a front view showing another embodiment of a video player.

### DETAILED DESCRIPTION OF THE PREFERRED EMBODIMENTS

The preferred embodiments of the present invention are explained below by referring to the attached drawings.

In the following explanation, an example of applying the display device according to the present invention to an electronic camera is explained, but the present invention is not limited to this application, but can be applied to any mobile PC such as a mobile telephone, a personal digital assistant (PDA), a pocket PC, etc., a portable game machines provided with a touch panel, an HDD audio player, etc.

In the following explanation, a touch panel is described as an example of the plate-like member with the switch member. However, in the present invention, the plate-like member is not limited to the touch panel, and various kinds of devices can be used as the plate-like member with the switch member.

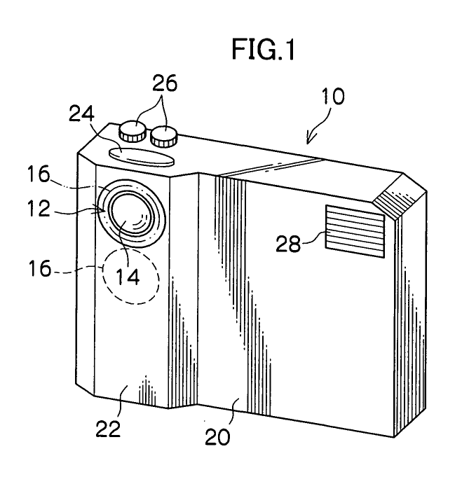

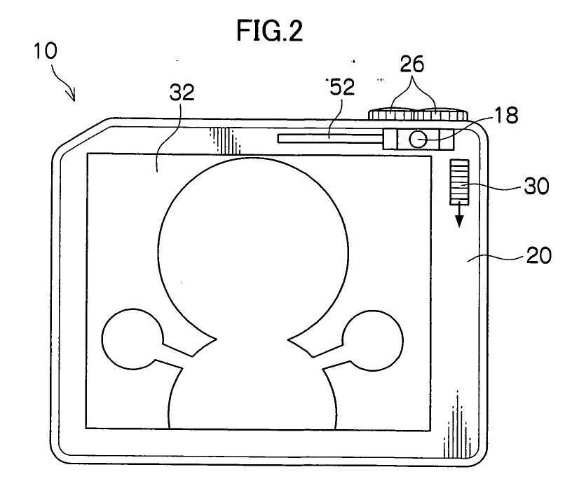

FIG. 1 is a front view of an electronic camera 10 to which the present invention is applied. FIG. 2 is a rear view of the camera. As shown in FIGS. 1 and 2, a capture unit 12 is provided at the upper left corner of the front face of the electronic camera 10. A CCD (not shown in the attached drawings) is arranged behind a taking lens 14 of the capture unit 12. A lens barrier (barrier member) 16 which releases and blocks the front surface of the taking lens 14 is included. The lens barrier 16 is coupled to a record-replay switch lever (record-replay switch device) 18 shown in FIG. 2 through a synchronization mechanism so that it can be operated in synchronization with the record-replay switching operation by the record-replay switch lever 18.

As shown in FIG. 1, the left portion of a camera body 20 including the capture unit 12 has a grip portion 22 developing forward for each grip of the camera body 20 by the right hand of a camera user. The camera body 20 has a landscape format, and has a shutter button 24, and a frame advance/frame return button 26 on the top surface. There is also an electronic flash emission unit 28 provided at the upper right corner of the front surface of the camera body 20.

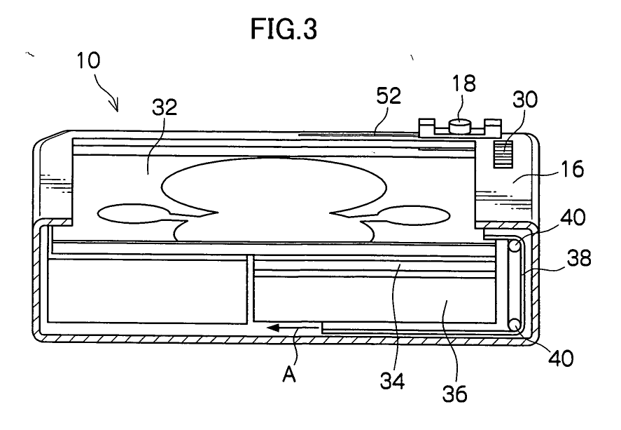

On the back of the grip portion 22, as shown in FIGS. 2 and 3, a power supply switch 30 which switches ON/OFF the main power supply is arranged. The power supply switch 30 is attached on the back of the camera body 20 such that the power supply switch 30 can freely slide up and down along the back, and is energized upwards by an energizing device not shown in the attached drawings. That is, the power is turned ON/OFF by sliding the power supply switch 30 downwards as shown in FIG. 2.

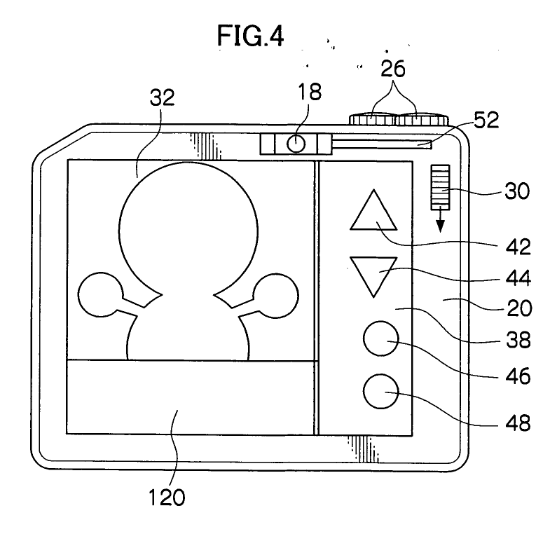

A monitor (display screen) 32 having a landscape format is provided on the back of the electronic camera 10. The monitor 32 is configured by a liquid crystal display (LCD), and is designed to be a landscape format screen as the largest possible screen for the camera body 20. On the full screen shown in FIG. 2, an image of a standard size (aspect ratio of 3:4) can be displayed. An image of a standard size can be reduced and displayed on the monitor 32 in the style shown in FIG. 4. In FIG. 3, a reference numeral 34 designates the substrate of a camera in which an electronic circuit is implemented, and a reference numeral 36 is a built-in chargeable buttery.

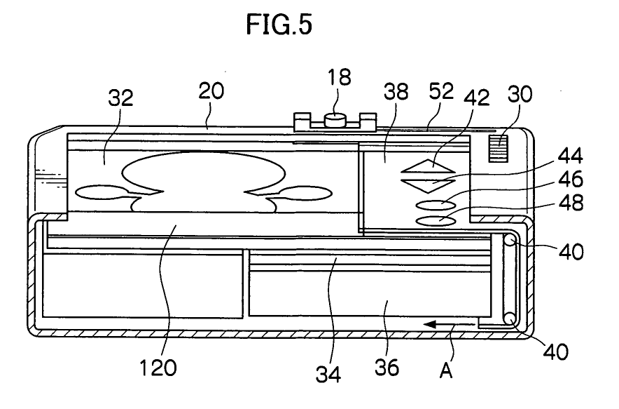

As shown in FIG. 4, a touch panel 38 is provided at the right side adjacent to the monitor 32. The touch panel 38 is made of a flexible material, for example, a plastic sheet, attached to a pair of rollers 40 provided in the camera body 20 at the right side of the camera body 20 as shown in FIG. 3, and flexed and moved between a drawn position covering the right portion (part) of the monitor 32 on the front surface of the monitor 32 shown in FIGS. 4 and 5 and a storage position on the side and back of the monitor 32 shown in FIGS. 2 and 3 as saved from the screen of the monitor 32. The touch panel 38 is energized in the storage direction (direction indicated by the arrow A shown in FIGS. 3 and 5) by the energizing member not shown in the attached drawings. With the arrangements, the storage space of the touch panel 38 can be saved by arranging the touch panel 38 in the camera body 20, and the camera body 20 can be compact. The touch panel 38 can be made of any flexible material, for example, a plastic sheet, organic EL (electro luminescence), inorganic EL, etc.

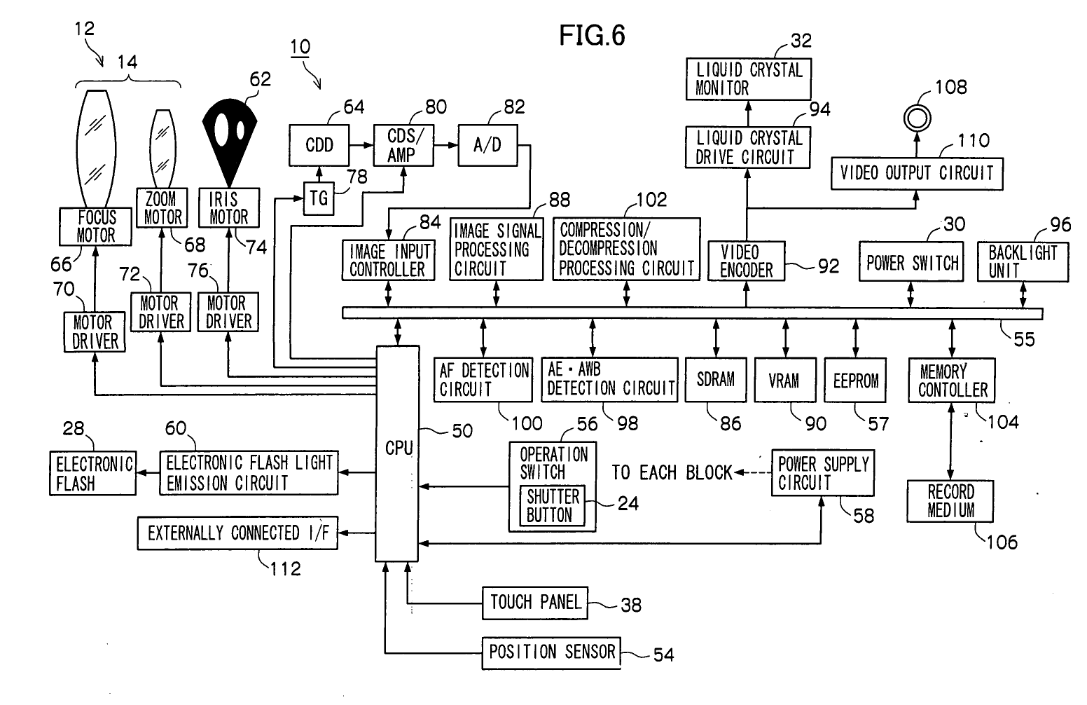

The touch panel 38 has a zoom tele-button 42 for operation during shooting, a zoom wide button 44, a macro shooting switch button 46, a strobe emission button 48, etc. arranged in predetermined positions. According to the signals received from the buttons 42 to 48, a CPU 50 shown in FIG. 6 changes the contents displayed on the monitor 32. The finger detecting system using the buttons 42 to 48 can be any of various devices such as a resistance film system, an electrostatic capacity system, an ultrasonic system, an optical system, etc.

The record-replay switch lever 18 which moves the touch panel 38 is provided at the upper portion on the back of the camera body 20 as shown in FIGS. 2 to 5. The record-replay switch lever 18 is attached as freely moved along a slit 52 formed horizontally to the 20, and coupled to the touch panel 38 through a coupling member not shown in the attached drawings. Along the slit 52, the record-replay switch lever 18 is slid and moved between the replaying position shown in FIGS. 2 and 3 and the shooting position shown in FIGS. 4 and 5, and engaged in the replaying position and the shooting position using a click mechanism not shown in the attached drawings. Thus, the touch panel 38 is held in the storage position shown in FIGS. 2 and 3 and the drawn position shown in FIGS. 4 and 5 against the energizing power of the energizing member.

A position sensor 54, which detects the record-replay switch lever 18 placed in the replaying position shown in FIGS. 2 and 3 and placed in the shooting position shown in FIGS. 4 and 5, is provided for the electronic camera 10 as shown in FIG. 6. A signal indicating the position of the touch panel 38 and issued from the position sensor 54 is output to the CPU 50 which centrally controls the electronic camera 10.

When the position sensor 54 issues a signal indicating the replaying position to the CPU 50, the CPU 50 recognizes the replay mode. When the position sensor 54 issues a signal indicating the shooting position to the CPU 50, the CPU 50 recognizes that the mode has been switched from the replay mode to the shooting mode. When a signal indicating the replaying position is input, the CPU 50 sets the image displayed on the monitor 32 for the standard size shown in FIGS. 2 and 3. When a signal indicating the shooting position is input, it sets the image displayed on the monitor 32 for the reduced size in replace of the standard size shown in FIG. 5. That is, the CPU 50 has the function of the display switch device.

The reduced size shown in FIGS. 4 and 5 is set as the size not to allow the touch panel 38 placed in the drawn position to hide an image. However, since the photo transmissive touch panel 38 can allow an image hidden by the touch panel 38 to be seen through the touch panel 38, it is not necessary to change the image size to a reduced size. The operability can be further improved by displaying an image corresponding to the operation on the screen covered by the touch panel 38.

FIG. 6 is a block diagram of the entire configuration of the electronic camera 10.

As shown in FIG. 50, the CPU 50 is connected to each block of the electronic camera 10 via a bus 55, and centrally controls each block based on the operation input from the touch panel 38 and an operation switch 56.

The operation switch 56 is a block including the shutter button 24, the frame advance/frame return button 26, and the power supply switch 30, and inputting operations to the electronic camera 10. The shutter button 24 has a two-stage configuration, that is, generates an S1=ON signal by a “half press”, and generates an S2 ON signal by a “full press”. The generated S1=ON signal and S2=ON signal are input to the CPU 50, and the CPU 50 detects the pressing status of the shutter button 24 according to the S1=ON and S2=ON signals.

EEPROM 57 stores a control program of the electronic camera 10 and various setting data, etc. necessary for control. A power supply circuit 58 provides a power source for each block of the electronic camera 10. The electronic flash emission unit 28 is controlled by an electronic flash emission circuit 60 at an electronic flash emission instruction from the CPU 50 based on the operation of the electronic flash emission button 48 of the touch panel 38.

The electronic camera 10 is provided with the taking lens 14, an iris 62, and a CCD 64 as capture devices. The focusing operation by the taking lens 14 is performed by moving a focus lens configuring the taking lens 14 using a focus motor 66, and the zooming operation is performed by moving a zoom lens configuring the taking lens 14 using a zoom motor 68. The focus motor 66 and the zoom motor 68 are driven and controlled respectively by a 70 and a zoom motor driver 72. The CPU 50 outputs a control signal to the focus motor driver 70 and controls it, and outputs a control signal to the zoom motor driver 72 based on the operation signals from the zoom tele-button 42, the zoom wide button 44, and the macro shooting switch button 46 of the touch panel 38 and controls it.

The iris 62 is configured by a so-called turret type iris, and changes a iris value (F value) by rotating the turret plate with iris holes of, for example, F2.8 to F8. The iris 62 is operated by an iris motor 74. The drive of the iris motor 74 is controlled by an iris motor driver 76. The CPU 50 outputs a control signal to the iris motor driver 76, and controls it.

The image light indicating a subject forms an image on the photoreceiving surface of the CCD 64 through the taking lens 14 and the iris 62. A number of photosensors are arranged on the photoreceiving surface of the CCD 64, and the optical image of the subject formed on the photoreceiving surface is converted to a signal charge of an amount corresponding to the amount of incident light by each photosensor. The signal charge accumulated in each photosensor is sequentially read according to the timing pulse from a timing generator (TG) 78, and output as a voltage signal depending on the signal charge to an analog signal processing circuit 80.

The CCD 64 is provided with a charge sweep drain, and the signal charge accumulation time (shutter speed) accumulated by each photosensor can be controlled by sweeping the signal charge accumulated in each photosensor to the charge sweep drain.

The analog signal processing circuit 80 includes a correlation double sampling process circuit (CDS) and an amplifier (AMP). For a voltage signal sequentially read by the CCD 64, the R, G, and B signals of each pixel is sampling held and amplified by the analog signal processing circuit 80, and the result is applied to an A/D converter 82.

The A/D converter 82 converts sequentially input analog R, G, and B signals to digital R, G, and B signals and outputs them, and the digital R, G, and B signals output from the A/D converter 82 are temporarily stored in memory (SDRAM) 86 through an image input controller 84. The R, G, and B signals are output from the SDRAM 86 to an image signal processing circuit 88.

The image signal processing circuit 88 performs predetermined signal processing such as an offset process, a gain control process including a white balance correction and a sensitivity correction, a gamma correction process, etc. on the input image signal, and the image data after the processing is output to VRAM 90.

The VRAM 90 includes an area A and an area B capable of storing a frame of image data, and a frame of image data is alternately rewritten to the areas A and B. Then, the rewritten image data is alternately read.

The image data read from the VRAM 90 is encoded by a video encoder 92, and output to the monitor 32 of the electronic camera 10. The monitor 32 is controlled by a liquid crystal drive circuit 94, and illuminated from the back of the monitor 32 by a backlight unit 96. A user determines the composition based on the through image displayed on the monitor 32 during shooting, and confirms the focusing status. The through image is an image of the reduced size as shown in FIG. 4. When the photo transmissive touch panel 38 is used, a through image is an image of the enlarged size as shown in FIG. 2.

In the shooting mode shown in FIG. 4, when the shutter button 24 is half pressed (S1=ON), automatic exposure adjustment (AE) and autofocus (AF) functions operate. That is, the image data output from the A/D converter 82 is input to an AE-AWB detection circuit 98 and an AF detection circuit 100 through the image input controller 84.

The AE-AWB detection circuit 98 divides the capture area into, for example, 64 divisions (8 horizontal divisions×8 vertical divisions), accumulates the R, G, and B image data for each of R, G, and B in each division area, and outputs the accumulation data for each of R, G, and b in each division area to the CPU 50.

The AF detection circuit 100 calculates the contrast evaluation value expressing the contrast of an image in the focus area (for example, the center of the capture area), and outputs the contrast evaluation value to the CPU 50.

The CPU 50 outputs a control signal to the focus motor driver 70 according to the contrast information input from the AF detection circuit 100, AF-controls the taking lens 14, and brings the main subject into focus.

The CPU 50 calculates the brightness (EV value) of the subject based on the accumulation data input from the AE-AWB detection circuit 98, and determines the iris value (F value) of the iris 62 based on the EV value, and the shutter speed (charge accumulation time) of the CCD 64.

When the AE and AF are completed, and the camera body 20 is fully pressed (S2=ON), the CPU 50 outputs the drive signal to the iris motor driver 76 based on the determined iris value (F value), controls the drive of the iris 62 such that the diameter of the iris based on the determined iris value (F value) can be obtained, and controls the charge accumulation time of the CCD 64 so that the determined shutter speed can be obtained.

The frame of image data captured as described above is input from the image input controller 84 to the SDRAM 86 through the analog signal processing circuit 80 and the A/D converter 82, and temporarily stored therein. Then, the data is read from the 86 to the image signal processing circuit 88, and a predetermined signal processing is performed including the process of generating brightness data and color different data (YC processing).

After the signal processing, the image data is temporarily stored in the SDRAM 86, and output to a compression/decompression processing circuit 102, and a predetermined compressing process such as JPEG (joint photographic experts group), etc. is performed. Then, the image data is temporarily stored again in the SDRAM 86, read by a memory controller 104, and recorded on a record medium 106 inserted into a card slot. The recording format of the image data is pot limited to the JPEG system, but any other recording systems such as the MPEG system, etc. can be adopted. The device for storing image data is not limited to a semiconductor memory represented by the record medium 106, but can be various media such as a magnetic disk, an optical disk, a magneto optical disk, etc. In addition to these removable media, a recording medium in the electronic camera 10 (inner memory) can also store image data.

Thus, the captured and recorded image data is fully displayed on the screen of the monitor 32 as shown in FIGS. 2 and 3 when the record-replay switch lever 18 switches the operation mode to the replay mode. In the replay mode, the image data recorded on the record medium 106 is read to the SDRAM 86, and is output from the SDRAM 86 to the compression/decompression processing circuit 102. Then, the compression/decompression processing circuit 102 performs a decompressing process, and the processed image data is temporarily stored in the SDRAM 86 and output to the monitor 32 through the video encoder 92. Thus, the image data recorded on the record medium 106 is replayed and displayed on the monitor 32. A user can advance or return frames of replayed images by operating the frame advance/frame return button 26.

When the external display such as a PC, television, etc. is connected to the electronic camera 10 through a video input/output terminal 108 in the replay mode, the image data recorded on the record medium 106 is processed by a video output circuit 110 and is replayed and displayed on the external display. The electronic camera 10 is connected to external equipment such as a personal computer, etc. through a cradle not shown in the attached drawings by an externally connected interface unit (I/F) 112.

Described below is the operation of the electronic camera 10 configured as described above.

The touch panel 38 provided on the back of the electronic camera 10 can be selectively placed in the storage position saved from the display screen of the monitor 32 as shown in FIGS. 2 and 3 or placed in the drawn position covering part of the display screen of the monitor 32 as shown in FIGS. 4 and 5. When the record-replay switch lever 18 moves the touch panel 38 to the storage position shown in FIGS. 2 and 3 with the power supply switch 30 turned to ON, the electronic camera 10 is switched to the replay mode by the CPU 50 shown in FIG. 6, and the display style is switched to an enlarged image in the standard size so that a replayed image can be displayed on the entire display screen of the monitor 32. When the record-replay switch lever 18 moves the touch panel 38 to the drawn position shown in FIGS. 4 and 5, the CPU 50 switches the operation mode to the shooting mode, and the display style is switched to a reduced image in the standard size so that a through image can be displayed on the screen except the overlapping portion of the touch panel 38. Furthermore, on a screen 120 as a marginal space below the reduced image in the standard size, characters indicating a chapter number, an F value, a shutter speed, etc. during shooting are displayed.

Thus, in the shooting mode not requiring a large screen for determination of the composition, the touch panel 38 is placed in the drawn position covering part of the display screen of the monitor 32, thereby reserving a larger area available for a grip portion by the area of the drawn area for the touch panel 38, and improving the gripping capability during shooting using the electronic camera 10. Additionally, since a user only has to touch each of the buttons 42 to 48 on the touch panel 38 covering part of the monitor 32 during operation, the dirt of the monitor 32 caused by the touch of a finger can be prevented.

Furthermore, during replay of an image shown in FIGS. 2 and 3, the touch panel 38 is placed in the storage position completely saved from the display screen of the monitor 32. Accordingly, a large screen can be realized during replay, and an enlarged image in a standard size can be displayed on the entire screen. As a result, a dynamic image can be appreciated.

In the electronic camera 10 according to an embodiment of the present invention, the camera body 20 has a landscape format, and the monitor 32 also has a landscape format. The touch panel 38 is stored in the camera body 20, and moved between the storage position and the drawn position covering part of the display screen. As shown in FIG. 4, the touch panel 38 can be preferably used as a grip portion by moving the touch panel 38 into and from the right side of the monitor 32.

In addition, the electronic camera 10 according to an embodiment of present invention has the lens barrier 16 as shown in FIG. 1. When the record-replay switch lever 18 is slid from the replaying position to the shooting position, the lens barrier 16 moves to the position in which the front surface of the taking lens 14 is released in synchronization with the sliding operation. Thus, the capture unit 12 can capture an image. When the record-replay switch lever 18 is slid from the replaying position to the replaying position, the lens barrier 16 moves to the position in which the lens barrier 16 blocks the front surface of the taking lens 14 in synchronization with the sliding operation. During replay, the capture unit 12 does not operate. Therefore, the lens barrier 16 blocks the front surface of the taking lens 14 and protects the capture unit 12. Thus, the operability can be improved by allowing the record-replay switch lever 18 to operate the lens barrier 16 in synchronization with the sliding operation.

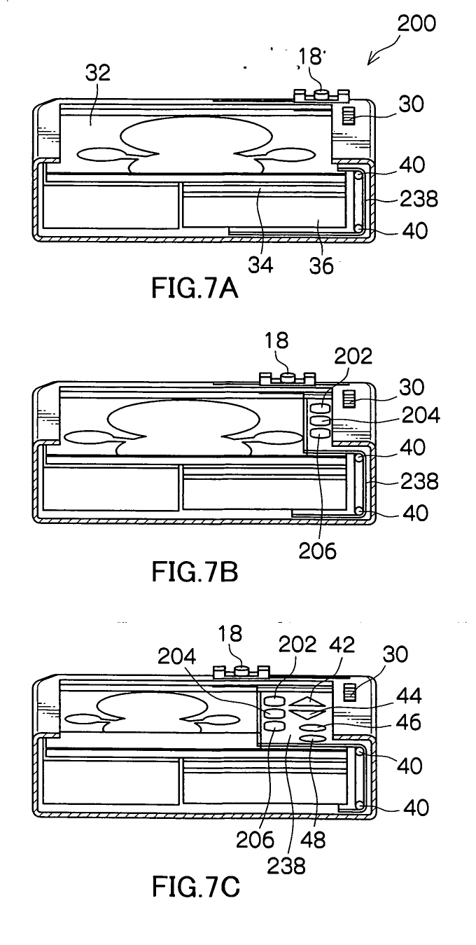

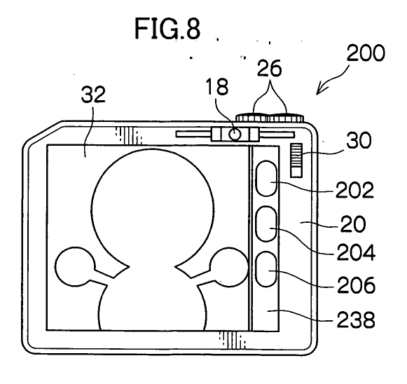

FIGS. 7A, 7B, 7C, and 8 show an electronic camera 200 according to another embodiment of the present invention. The members the same as or similar to the members of the electronic camera 10 shown in FIGS. 1 to 6 are assigned the same reference numerals in giving explanation.

The electronic camera 200 shown in FIGS. 7A, 7B, 7C is provided with the record-replay switch lever 18 which has the function of a power supply switch and is engaged in the power OFF position shown in FIG. 7A, the power ON and shooting position (first position covering part of the display screen) shown in FIG. 7C, and the power ON and replaying position (second position covering an area smaller than the part of the display screen) shown in FIGS. 7B and 8.

A touch panel 238 operated in synchronization with the sliding operation of the record-replay switch lever 18 is provided with the zoom tele-button 42, the zoom wide button 44, the macro shooting switch button 46, the strobe emission button 48 exposed in the power ON and shooting position shown in FIG. 7C, and a picture search button 202, a temporary stop button 204, a fast forward/rewind button 206, etc. exposed in the power ON and replaying position shown in FIGS. 7B and 8 which are minimally required during replay.

With the above-mentioned configuration of the electronic camera 200, during shooting shown in FIG. 7C and not requiring a large screen, a large area available as a grip portion can be reserved by placing a touch panel 238 in the position covering part of the monitor 32, thereby improving the gripping capability during operation.

Since a user only has to touch the touch panel 238 covering part of the monitor 32 during operation, the dirt of the display screen caused by the touch of a finger can be prevented. At this time, the through image is displayed on the screen except the part. That is, the CPU (not shown in the attached drawings) of the electronic camera 200 switches the display style to display a through image on the screen except the part when the touch panel 238 is placed in the position covering part of the display screen of the monitor 32.

On the other hand, during replay shown in FIGS. 7B and 8, the touch panel 238 is placed in the position exposing only the minimally required operation buttons 202, 204, and 206. Therefore, a large screen can be realized during replay with the operation buttons 202, 204, and 206 required during replay.

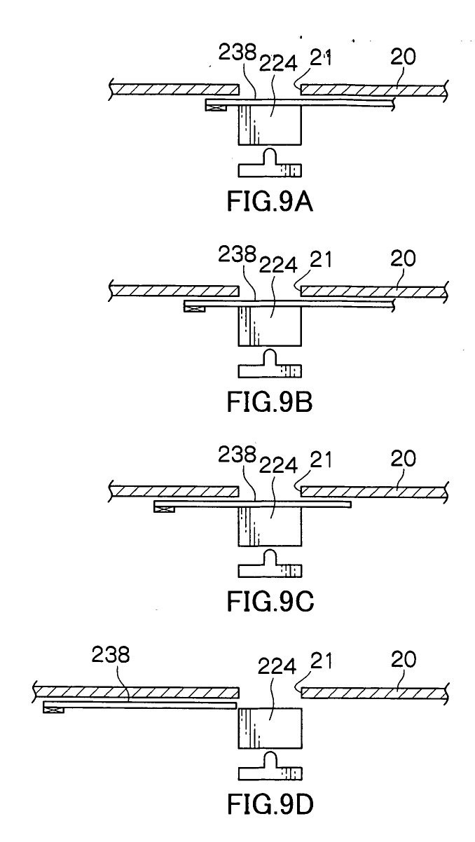

FIGS. 9A, 9B, 9C, and 9D show the relationship between the touch panel 238 and a shutter button 224. In FIGS. 9A, 9B, 9C, and 9D, the shutter button 224 is covered by the touch panel 238 in the power OFF position of the touch panel 238 shown in FIG. 9A. Therefore, it cannot be operated. Also in the power ON position of the touch panel 238 shown in FIG. 9B and in the power ON and replaying position shown in FIG. 9C, the shutter button 224 is continuously covered by the touch panel 238. Therefore, it cannot be operated. When the touch panel 238 is placed in the power ON and shooting position shown in FIG. 9D, the touch panel 238 passes above the shutter button 224, and the shutter button 224 is exposed at an aperture 21 of the camera body 20, it can be operated.

With the above-mentioned configuration of the touch panel 238 and the shutter button 224, the shutter button 224 can be operated only during replay, thereby preventing a malfunction of the shutter button 224.

In addition, by totally covering the monitor 32 with the touch panel 238, the touch panel 238 can protect the monitor 32.

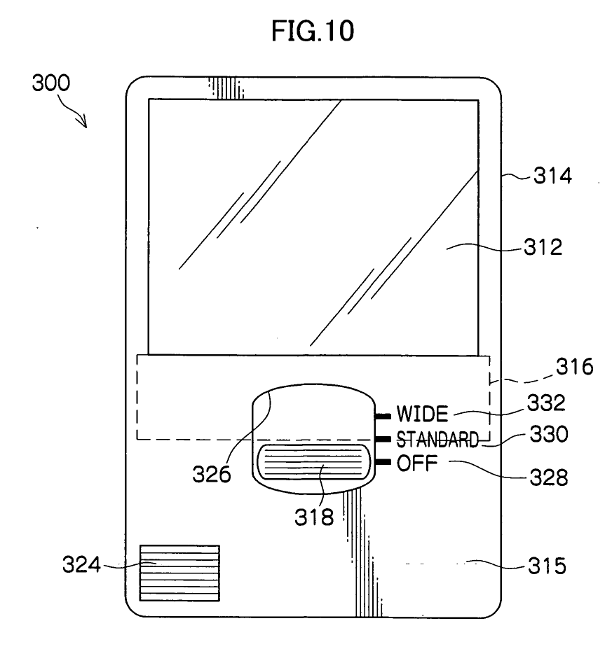

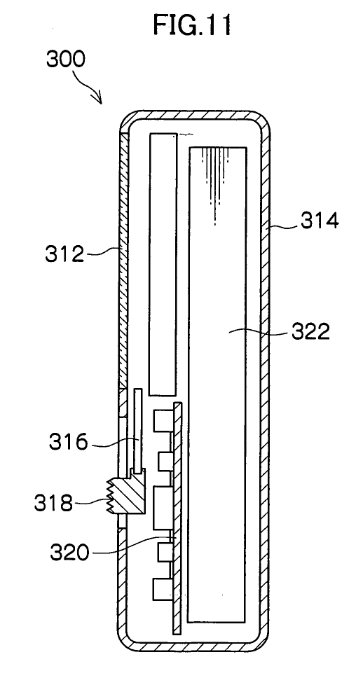

FIG. 10 is a front view of a video player 300 to which the present invention is applied. FIG. 11 is a longitudinal sectional view of the player. As shown in FIG. 10, a landscape format monitor (display screen) 312 is provided at the upper part of the front surface of the video player 300. The monitor 312 is configured by a liquid crystal display (LCD), and a largest possible landscape format screen is used for a portrait format device body 314.

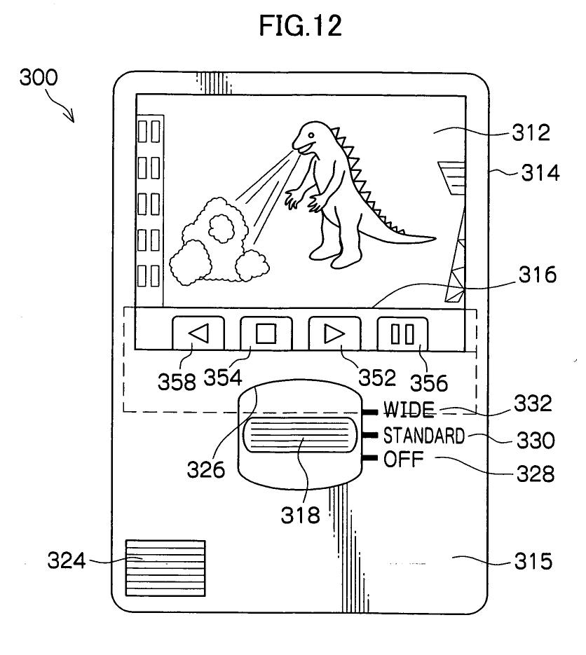

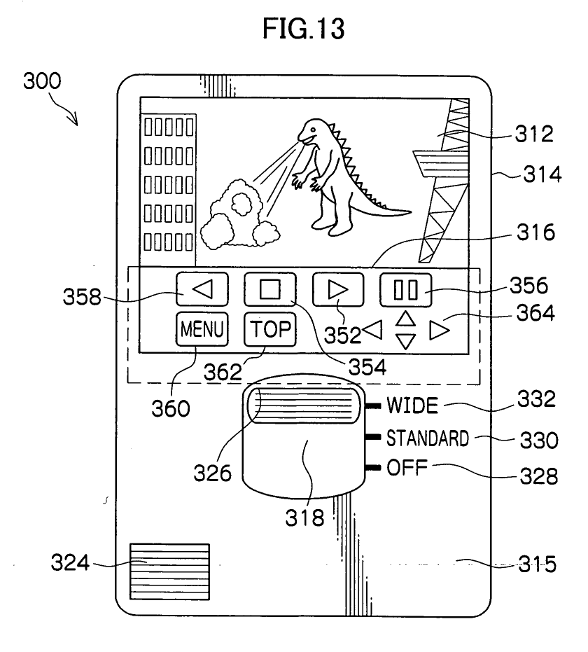

Furthermore, the monitor 312 can display an image of a standard size (aspect ratio 3:4) shown in FIG. 12 and an image of a wide size (aspect ratio 9:16) shown in FIG. 13 based on the operation of a slide lever 318 switching the power source switch, switching a screen size, and moving a touch panel 316 forward and backward on the monitor 312. In FIG. 11, a reference numeral 320 designates a circuit substrate in which an electronic circuit is implemented, and a reference numeral 322 designates a built-in HDD (hard disc drive). A reference numeral 324 designates a speaker arranged at the lower left corner of the device body 314. In the video player 300, the device body at the lower portion of the player is used as a grip portion 315, and the slide lever 318 is provided at the position in which a user's finger of the right or left hand holding the grip portion 315 can operate the lever.

The slide lever 318 is mounted such that the lever can freely slide up and down on an aperture 326 formed on the front surface of the device body 314, and can be held at an OFF position 328 at the lower stage, a standard position 330 at the intermediate stage, and a wide position 332 at the upper stage using a click mechanism not shown in the attached drawings. When the slide lever 318 is held at the OFF position 328, the power supply of the video player 300 is turned OFF. When the slide lever 318 is held at the standard position 330 or the wide position 332, the power supply of the video player 300 is turned ON.

The slide lever 318 and the touch panel 316 are coupled within the device body 314 as shown in FIG. 11. The touch panel 316 is arranged at the lower position adjacent to the monitor 312 as shown in FIGS. 12 and 13, and has a landscape format wider that the monitor 312. The touch panel 316 is configured by a plastic plate, stored by the 314, and placed in the position saved from the monitor 312 by operating the slide lever 318 to the OFF position 328 as shown in FIG. 10. The touch panel 316 can also be placed in the first drawn position (first position) covering the lower portion (part of) the monitor 312 by operating the slide lever 318 to the wide position 332 as shown in FIG. 13. When the slide lever 318 is placed in the standard position 330 as shown in FIG. 12, it is placed in the position covering the lower portion of the monitor 312 and the second drawn position (second position) having a smaller covering area by the touch panel 316 than the drawn position shown in FIG. 13. In the second drawn position shown in FIG. 12, the screen except the screen covered by the touch panel 316 has the screen size corresponding to the standard size (aspect ratio 3:4). In the first drawn position shown in FIG. 13, the screen except the screen covered by the touch panel 316 has the screen size corresponding to the wide size (aspect ratio 9:16).

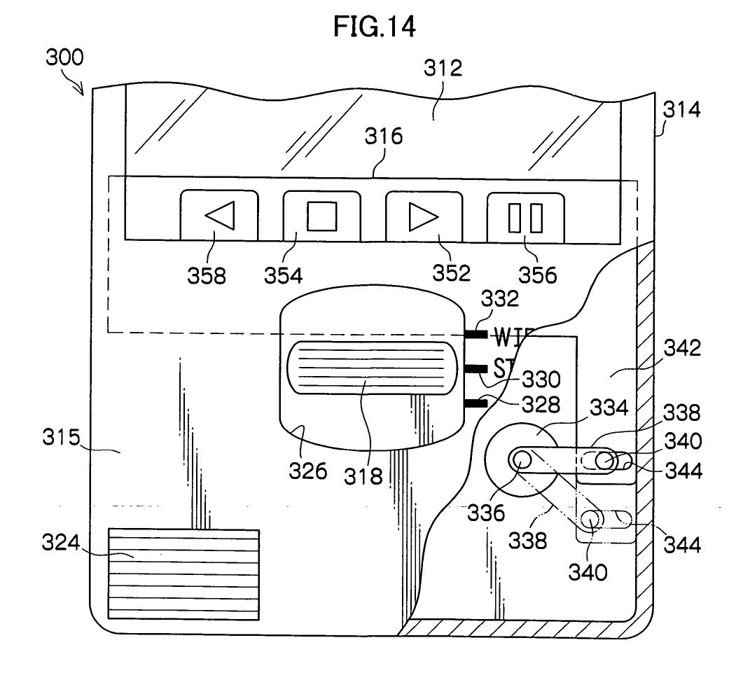

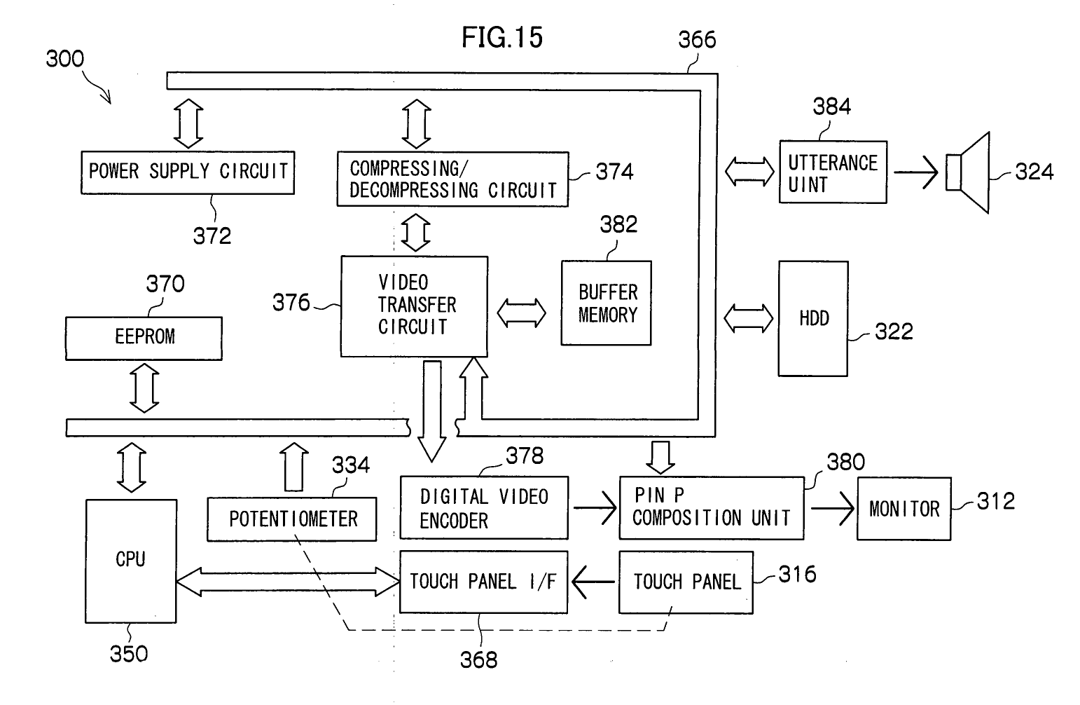

Furthermore, the video player 300 has a built-in potentiometer 334 in the device body 314 as shown in FIG. 14. The potentiometer 334 detects the slide lever 318 placed in the OFF position 328 shown in FIGS. 10 and 11, in the standard position 330 shown in FIG. 12, and in the wide position shown in FIG. 13. According to the potentiometer 334, one end of an arm 338 is coupled to a rotation axis 336 of the potentiometer 334, and the other end of the arm 338 is engaged in a long hole 344 formed in a coupling flap 342 of the touch panel 316. Therefore, when the touch panel 316 is moved up and down by the operation of the slide lever 318, the arm 338 and the rotation axis 336 rotate in synchronization with the movement, and a signal depending on the amount of rotation, that is, a signal indicating the position of the touch panel 316, is output from the potentiometer 334 to the CPU 50 (FIG. 15) which centrally controls the video player 300.

When a signal indicating that the slide lever is placed in the OFF position 328 is output from the potentiometer 334 to a CPU 350, the CPU 350 turns OFF the power supply. When a signal indicating that the slide lever is placed in the standard position 330 is output from the potentiometer 334 to the CPU 350, the CPU 350 recognizes that a standard digital camera has been selected, thereby setting an image displayed on the monitor 312 to the standard size (aspect ratio 3:4) shown in FIG. 12. Thus, the image of the same standard size is fully displayed on the screen of the standard size except the screen covered by the touch panel 316. Furthermore, when a signal indicating that the slide lever is placed in the wide position 332 is output from the potentiometer 334 to the CPU 350, the CPU 350 recognizes that the wide screen has been selected, and sets the image displayed on the monitor 312 to the wide size (aspect ratio 9:16) shown in FIG. 13. Thus, the image of the same wide size is fully displayed on the screen of the wide size except the screen covered by the touch panel 316. That is, the CPU 350 has the function of the display control device.

The images shown in FIGS. 12 and 13 are set to the size in which an image is not hidden by the touch panel 316. However, a photo transmissive touch panel 316 allows an image hidden by the touch panel 316 to be seen through the touch panel 316. Therefore, it is not necessary to stop the screen covered by the touch panel 316 from being displayed.

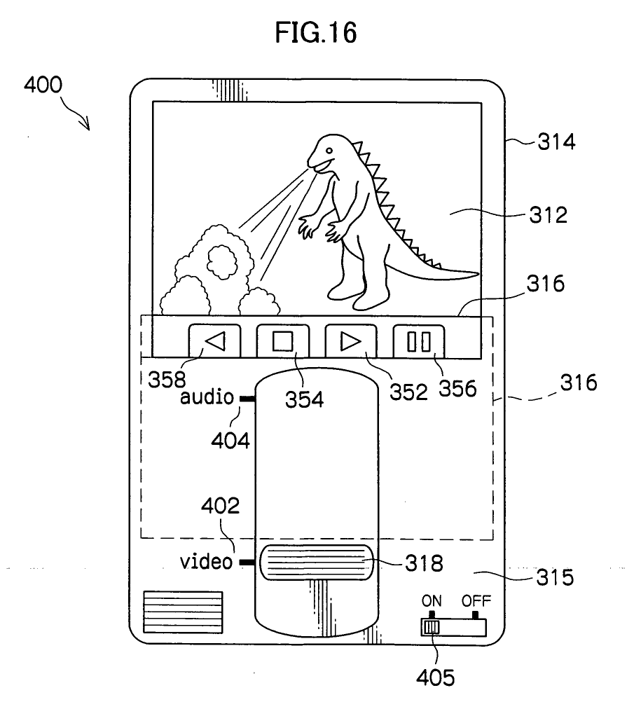

The touch panel 316 is provided as shown in FIG. 13 with a start button 352, a stop button 354, a temporary stop button 356, a rewind button 358, a menu selection button 360 a top button 362, and a cross key button 364 arranged in each position to be operated when an image is replayed. In these buttons 352 to 364, the start button 352, the stop button 354, the temporary stop button 356, and the rewind button 358 are exposed on the monitor 312 in the standard size shown in FIG. 12, and all buttons 352 to 364 are exposed on the monitor 312 in the wide size shown in FIG. 13. Depending on the signal received from these buttons 352 to 364, the CPU 350 shown in FIG. 16 changes the contents displayed on the monitor 312. The system of detecting a finger using the buttons 352 to 364 can be selected from among various systems such as a resistance film system, a electrostatic capacity system, a ultrasonic system, an optical system, etc.

A display format of each of the buttons 352 to 364 can be realized by configuring the touch panel 316 by a photo transmissive member, displaying only the frame of each of the buttons 352 to 364 on the touch panel 316, and displaying the symbols and characters (corresponding to the image related to the operation of the touch panel) in the frame on the monitor 312 such that the they can correspond to the position of the frame. Furthermore, all of the frame, symbols, and characters can be displayed on the monitor 312, and clear buttons 352 to 364 can be formed on the touch panel 316. In addition, an image can be displayed on the full screen of the monitor 312 shown in FIG. 10. Thus, a large screen can be realized during replay, and an image can be fully displayed on the screen of the monitor 312. Therefore, a dynamic image can be appreciated. In this case, since the slide lever 318 functions only as a switching member of the screen size, a power supply switch is additionally required.

FIG. 15 is a block diagram of the entire configuration of the video player 300.

As shown in FIG. 15, the CPU 350 is connected to each block of the video player 300 through a bus 366, and centrally controls each block based on the operation input from the touch panel 316 through a touch panel I/F 368.

EEPROM 370 stores a control program of the video player 300, various setting data, etc. required for control. A power supply circuit 372 provides power for each block of the video player 300.

The HDD 322 stores image data and audio data of static images and moving pictures. The image data read from the HDD is decompressed by a compressing/decompressing circuit 374, and then converted to a video signal by a video transfer circuit 376. Then, the signal is encoded by a digital video encoder 378 and combined into an image by a Pin P composition unit 380, and output to the monitor 312 of the video player 300. The video signal converted by the video transfer circuit 376 is temporarily stored in buffer memory 382. On the other hand, the audio signal read by the HDD 322 is output through an utterance unit 384, and voice is uttered from the speaker 324.

Described below is the operation of the video player 300 with the above-mentioned configuration.

The lens barrier 16 provided on the front surface of the video player 300 can be placed in the storage position saved from the display screen of the monitor 312 as shown in FIG. 10, and the first drawn position and the second drawn position covering part of the display screen of the monitor 312 as shown in FIGS. 12 and 13.

When the slide lever 318 is moved from the OFF position 328 shown in FIG. 10 to the standard position 330 shown in FIG. 12, the video player 300 is turned ON and an image of a standard size is fully displayed as shown in FIG. 12 on the screen of the standard size of the monitor 312 not covered by the touch panel 316. When the slide lever 318 is moved from the standard position 330 shown in FIG. 12 to the wide position 332 shown in FIG. 13, an image of a wide size is fully displayed as shown in FIG. 13 on the screen of the wide size of the monitor 312 not covered by the touch panel 316.

As described above, by placing the touch panel 316 in the first and second drawn positions covering part of the display screen of the monitor 312 when an image is replayed, the area available as a grip portion can be larger by the drawn area of the touch panel 316. As a result the gripping capability can be improved during replay by the video player 300. When an image is replayed, a user only has to touch each of the buttons 362 to 364 of the touch panel 316 covering part of the monitor 312. Therefore, the dirt of the wide position 332 caused by the touch of a finger can be prevented.

In the video player 300 according to an embodiment of present invention, the device body 314 has a portrait format, and the monitor 312 has a landscape format. The touch panel 316 is stored in the device body 314, and is moved between the storage position and the first and second drawn positions covering part of the display screen. As shown in FIGS. 12 and 13, by moving the touch panel 316 to and from the lower portion of the monitor 312, the touch panel 316 can be preferably used as a grip because the grip portion 315 is formed below the monitor 312.

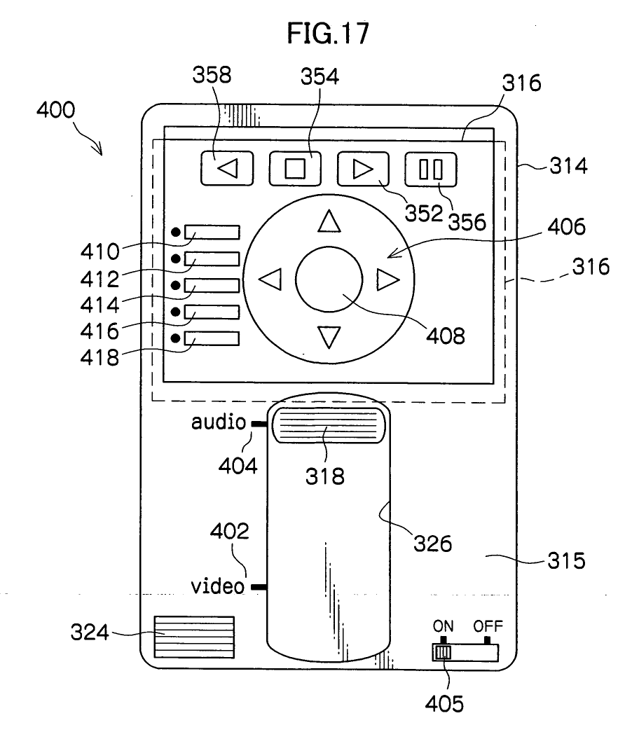

FIGS. 16 and 17 show a video-audio player 400 according to another embodiment of the present invention. The same or similar members as or to these of the video player 300 shown in FIGS. 10 to 15 are assigned the same reference numerals and explained.

In the video-audio player 400 shown in FIG. 16, the slide lever 318 has the function of a switch which switches between the image replay mode and the music replay mode, and is engaged in an image replay mode position 402 shown in FIG. 16 and a music replay mode position 404 shown in FIG. 17 by the click mechanism not shown in the attached drawings. A power supply switch 405 is provided for the device body 314 of the video-audio player 400.

The photo transmissive touch panel 316 operating in synchronization with the sliding operation of the slide lever 318 is provided with the start button 352, the stop button 354, the temporary stop button 356, and the rewind button 358 positioned on the monitor 312 in the image replay mode shown in FIG. 16, and a music operation cross key button 406 and a determination button 408 positioned on the monitor 312 in the music replay mode shown in FIG. 16.

In the music replay mode shown in FIG. 17, the touch panel 316 covers the entire screen of the monitor 312, and when a music title is selected in the operation of the music operation cross key button 406, the monitor 312 displays plural titles of music (images relating to the operations of the music replay mode of the touch panel) are displayed in characters in areas 410, 412, 414, 416, and 418 shown in FIG. 17. Using the music operation cross key button 406, these titles can be scrolled on the monitor 312. Then, after moving the cursor to a desired title by operating the music operation cross key button 406, the determination button 408 is operated to select the title of music.

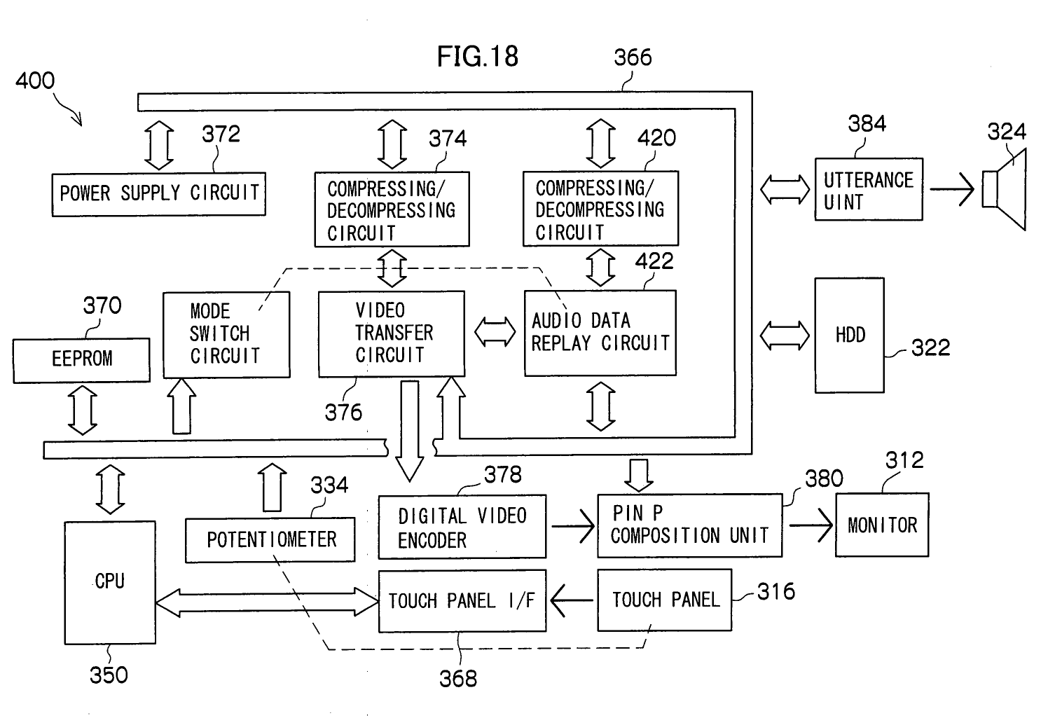

FIG. 18 is a block diagram of the entire configuration of the video-audio player 400. The same or similar members as or to these in the block diagram shown in FIG. 15 are assigned the same reference numerals and the explanation is omitted here.

As shown in FIG. 18, the music data read from the HDD 322 is decompressed by a compressing/decompressing circuit 420, then replayed by a audio data replay circuit 422, and output to the speaker 324 through the utterance unit 384.

According to the video-audio player 400 with the above-mentioned configuration, since the touch panel 316 covers the entire screen of the wide position 332 in the music replay mode shown in FIG. 17 not requiring the screen, a large area available as the grip portion can be reserved. Therefore, the gripping capability in the music replay operation can be improved.

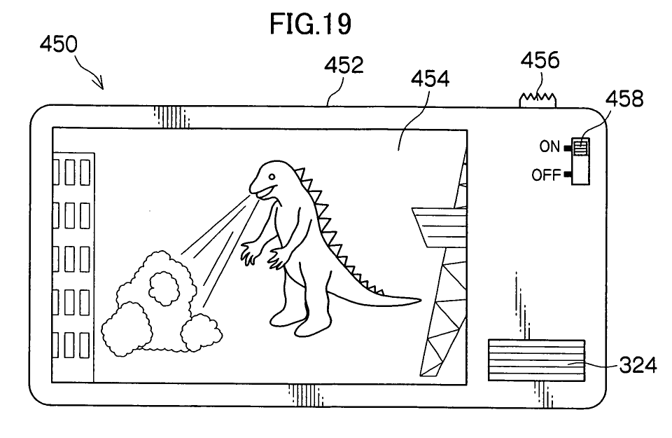

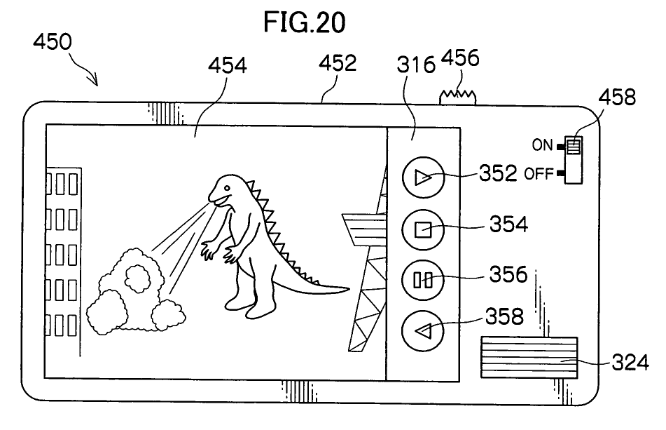

A video player 450 shown in FIGS. 19 and 20 has a landscape format device body 452 provided with a landscape format monitor 454. The touch panel 316 is moved between the position saved from the monitor 454 at the right side of the monitor 454 shown in FIG. 19 and the position covering part of the monitor 454 shown in FIG. 20. The operation of moving the touch panel 316 is performed by sliding a lever 456 provided on the top surface of the device body 452.

With the video player 450, when a power supply switch 458 is turned ON, an image is displayed on the monitor 454, and when the lever 456 is slid to the left as shown in FIG. 20, the touch panel 316 is placed in the position covering part of the monitor 454, and the exposed buttons then, that is, the start button 352, the stop button 354, the temporary stop button 356, and the rewind button 358, can be operated.

What is claimed is:

1. A display device, comprising:
a device body having a display screen; and
a plate-like member with a switch member, the plate-like member movable to a position covering part of the display screen and a position saved from the display screen.

2. The display device according to claim 1, wherein
the device body has a landscape format,
the display screen has a landscape format, and
the plate-like member is stored in the device body and moved between a storage position and the position covering part of the display screen.

3. The display device according to claim 1, further comprising a record-replay switch device,
wherein the plate-like member is moved between the position covering part of the display screen and the position saved from the display screen in synchronization with a switching operation of the record-replay switch device, and can be used in an operation relating to recording in the position covering part of the display screen.

4. The display device according to claim 2, further comprising a record-replay switch device, wherein
the plate-like member is moved between the position covering part of the display screen and the position saved from the display screen in synchronization with a switching operation of the record-replay switch device, and can be used in an operation relating to recording in the position covering part of the display screen.

5. The display device according to one of claim 1,
wherein the plate-like member is configured by a flexible material, and is flexed and moved from the position covering part of the display screen on a front surface of the display screen to the position on a back of the display screen and saved from the front surface of the display screen.

6. The display device according to one of claim 4, wherein
the plate-like member is configured by a flexible material, and is flexed moved from the position covering part of the display screen on a front surface of the display screen to the position on a back of the display screen and saved from the front surface of the display screen.

7. The display device according to claim 6, further comprising:
a capture unit; and
a barrier member which opens and closes a front surface of the capture unit,
wherein the barrier member is moved to a position in which the front surface of the capture unit is opened and a position in which the front surface of the capture unit is closed in synchronization with an operation of the record-replay switch device.

8. The display device according to claim 1, wherein the plate-like member is a photo transmissive touch panel.

9. The display device according to claim 7, wherein the plate-like member is a photo transmissive touch panel.

10. A display device, comprising:
a device body having a display screen;
a plate-like member with a switch member, the plate-like member movable to a first position covering part of the display screen and a second position covering an area smaller than the part of the display screen; and
a display control device which changes a display style of the display screen depending on a movement of the plate-like member from the second position to the first position.

11. A display device, comprising:
a device body having a display screen; and
a plate-like member with a switch member, the plate-like member movable to a position covering the display screen and a position saved from the display screen,
wherein the plate-like member is configured by a flexible material, and is flexed and moved from a position covering all or part of the display screen on a front surface of the display screen to a position on a back of the display screen saved from the front surface of the display screen.

12. A display device, comprising:
a device body having a display screen; and
a plate-like member with a switch member, the plate-like member movable to a position covering all or part of the display screen and a position saved from the display screen.

13. The display device according to claim 12, wherein
the device body has a portrait format,
the display screen has a landscape format, and
the plate-like member is stored in the device body and moved between a storage position and the position covering all or part of the display screen.

14. The display device according to claim 12, wherein
the plate-like member is configured by a photo transmissive member, and
when the plate-like member is moved to a position covering all or part of the display screen, the display screen displays an image related to an operation of the plate-like member.

15. The display device according to claim 13, wherein
the plate-like member is configured by a photo transmissive member, and
when the plate-like member is moved to a position covering all or part of the display screen, the display screen displays an image related to an operation of the plate-like member.

16. The display device according to claim 13, wherein
the plate-like member is configured to be movable to a first position covering part of the display screen and a second position covering an area smaller than the part of the display screen, and
a display control device is provided to change a display style of the display screen depending on a movement of the plate-like member from the second position to the first position.

17. The display device according to claim 12, further comprising:
a display control device which changes an aspect ratio of an image displayed on the display screen depending on a movement position of the plate-like member.

18. The display device according to claim 13, further comprising:
a display control device which changes an aspect ratio of an image displayed on the display screen depending on a movement position of the plate-like member.

19. The display device according to claim 16, further comprising:
a display control device which changes an aspect ratio of an image displayed on the display screen depending on a movement position of the plate-like member.

20. A display device, comprising:
a device body having a display screen;
a plate-like-member with a switch member, the plate-like member movable to a position covering all or part of the display screen and a position saved from the display screen; and
a mode switch device which switches replay modes between an image replay mode and a music replay mode depending on a movement position of the plate-like member.

21. The display device according to claim 20, wherein
the plate-like member is configured by a photo transmissive member, and
when the plate-like member is moved to a position covering all the display screen, the mode switch device switches replay mode to the music replay mode and the display screen displays an image related to an operation of the plate-like member in the music replay mode.
